(19) United States
(12) Patent Application Publication
(10) Pub. No.: US 2023/0111685 A1
(43) Pub. Date: Apr. 13, 2023

(54) RESEALABLE LIDDING FILM FOR USE ON COMPOSTABLE TRAYS

(71) Applicant: FASTIK LABEL & SUPPLY INC., LANGLEY (CA)

(72) Inventor: Brad Malchuk, Langley (CA)

(21) Appl. No.: 18/046,084

(22) Filed: Oct. 12, 2022

Related U.S. Application Data
(63) Continuation of application No. PCT/IB2022/051438, filed on Feb. 17, 2021.
Application No. PCT/IB2022/051438 is a continuation of application No. 63/150,567, filed on Feb. 17, 2021.

(51) Int. Cl. B32B 7/06; B65D 77/20; B32B 3/26; B32B 7/12; B32B 27/08; B32B 5/02

(52) U.S. Cl. CPC B32B 7/06; B65D 77/2048; B65D 77/2064; B32B 3/266; B32B 7/12; B32B 27/08; B32B 5/02; B32B 2255/26; B32B 2307/7163

(57) ABSTRACT

According to some embodiments, a resealable lidding film is provided. The resealable lidding film includes a first layer capable of being attached to a compostable container according to some embodiments. In certain embodiments, the first layer can include a first layer top surface; a first layer bottom surface; a release coating applied to at least a portion of the first top surface of the first layer; and one or more score lines. The resealable lidding film also includes a second layer lacking score lines according to some embodiments. The resealable lidding film also includes an adhesive layer between the release coating of the first layer and the second layer according to some embodiments. In other embodiments, the resealable lidding film includes a first layer capable of being attached to a compostable container and a second layer having a release coating applied to at least a portion of a top surface of the second layer; and one or more score lines through the first and second layers. The resealable lidding film includes also includes a third layer lacking score lines. In some embodiments, the resealable lidding film includes a permanent adhesive layer between the first and second layers and a pressure sensitive adhesive layer between the second and third layers.

### CROSS REFERENCE TO RELATED APPLICATIONS

This application is a continuation of International Application No. PCT/IB2022/051438, filed Feb. 17, 2022, which claims the benefit of U.S. provisional patent Application No. 63/150,567, filed Feb. 17, 2021, both of which are incorporated herein by reference in their entirety.

### BACKGROUND

Resealable lidding films have traditionally been attached to polymer-based plastic containers to form single use packaging for food and other items. However, waste and trash created by disposable plastics have taken a toll on the environment, polluting the ocean and land and endangering the animals living there. Therefore, it is desirable to produce alternative, sustainable and compostable packaging container options to reduce the environmental burden.

Using compostable fiber containers are one option to help reduce plastic pollution. However, the seal strength on fiber containers using conventional resealable film is significantly lower than that on traditional plastic trays. Therefore, it is more difficult to design a successful resealable film because resealable film requires a certain amount of adhesion strength to the containers, and that adhesion strength needs to be greater than the peel force required to separate the two or three layers of film. As such, it is desired to design a resealable lidding film for use on fiber containers that has a reduced peel force than traditional designs.

### SUMMARY

According to the embodiments provided herein, a resealable lidding film is provided. In some embodiments, the resealable lidding film includes a first layer capable of being attached to a compostable (e.g., fiber-based) container according to some embodiments. In certain embodiments, the first layer includes a top surface; a bottom surface; a release coating applied to at least a portion of the top surface of the first layer;

and one or more score lines which allows for separation and opening of the container. The resealable lidding film also includes a second layer lacking score lines according to some embodiments. The resealable lidding film also includes an adhesive layer between the release coating of the first layer and the second layer according to some embodiments. In some embodiments, a third layer of film may be added as a lamination with permanent adhesive.

In other embodiments, the resealable lidding film includes a first layer capable of being attached to a compostable container and a second layer having a release coating applied to at least a portion of a top surface of the second layer; and one or more score lines through the first and second layers. The resealable lidding film includes also includes a third layer lacking score lines. In some embodiments, the resealable lidding film includes a permanent adhesive layer between the first and second layers and a pressure sensitive adhesive layer between the second and third layers.

According to some embodiments, a packaging unit is provided. In certain embodiments, the packaging unit includes a compostable container having an opening and a receptable for holding goods; and a resealable lidding film. The resealable lidding film may include two or more layers of film in accordance with the embodiments described above.

### BRIEF DESCRIPTION OF THE DRAWINGS

These and other features will become more apparent from the following description in which reference is made to the appended drawings, the drawings are for the purpose of illustration only and are not intended to be in any way limiting.

FIG. 1 is a cross-section view of a portion of a resealable lidding film having two film layers according to some embodiments.

FIG. 2 is a cross-section view of a portion of a resealable lidding film having three film layers according to some embodiments.

FIG. 3 is a cross-section of a packaging unit having a resealable lidding film having two film layers like that shown in FIG. 1 shown in an open state according to some embodiments.

FIG. 4 is a cross-section of a packaging unit having a resealable lidding film having two film layers like that shown in FIG. 2 shown in an open state according to some embodiments.

FIG. 5 is a bottom view of two resealable lidding films prior to being cut from a roll of film and showing score line and sealing line details of the first layer as well as the shape of the resealable lidding films as indicated by cut lines according to some embodiments.

FIG. 6A is a top view of a resealable lidding film with a corner peel tab pulled back showing details of the release coating, score lines and seal lines of the first layer, as well as optional micro-perforations according to some embodiments.

FIG. 6B is a top view of a resealable lidding film with a leading-edge peel tab showing details of score lines and seal lines of the first layer according to some embodiments.

FIG. 7 is a side elevation view of a manufacturing process for producing the resealable vented multilayer film according to some embodiments.

FIG. 8 is a perspective view of a packaging unit having a resealable lidding film including a pressure sensitive film label applied on top of the sealed portion of the lidding film according to some embodiments.

### DETAILED DESCRIPTION

A method of manufacturing a resealable vented multilayer film for use in heat sealable tray sealing machines and a resealable vented multilayer film.

### DETAILED DESCRIPTION

Described herein is a resealable lidding film for use with compostable containers, packaging unites using said resealable lidding film, and methods for making and manufacturing the same.

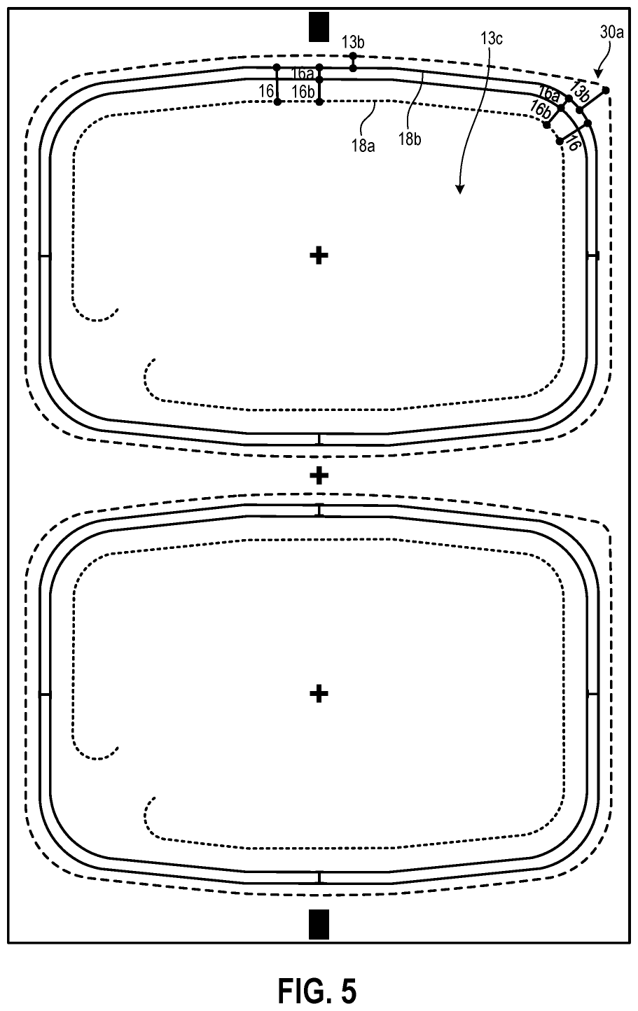

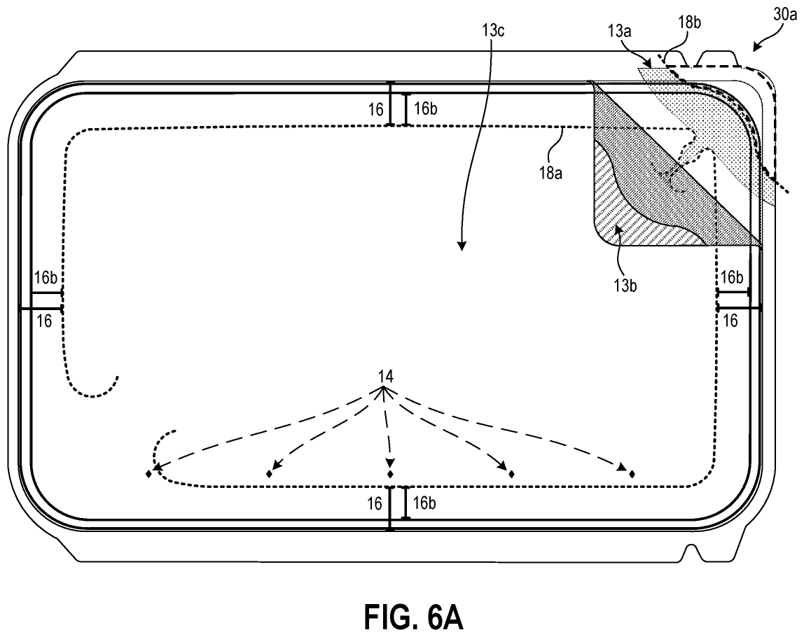

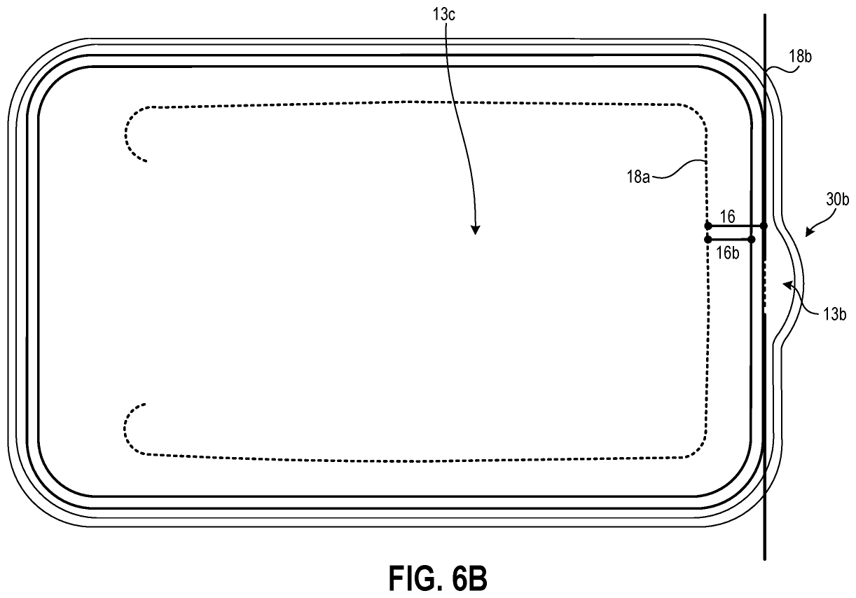

According to the embodiments described herein, the resealable lidding film may be attached to a compostable container to form a packaging unit that may be opened and resealed by a user. The compostable container may be produced by any from any suitable compostable or compostable material, examples include, but are not limited to, compostable plastic materials, starch-based materials, fiber- or pulp-based materials. The base of fiber- or pulp-based materials may include, but is not limited to, newspaper, post-consumer waste (e.g., corrugated boxes cartons, bags and waste paper) and plant fibers (e.g., wood fiber, bamboo fiber, straw fiber, sugarcane fiber (“bagasse”)). The compostable container may have any shape (e.g. rectangular as shown in the figures, square, triangular, round, oval, elliptical, etc.) with a receptacle portion for holding consumer goods or food and an opening that is covered by the resealable lidding film. As such, in some embodiments, the resealable lidding film is cut in the same shape as the opening. In other embodiments, the resealable lidding film is generally the same shape as the opening but includes one or more additional shapes that extend from the general shape. For example, as shown in FIGS. 5, 6A, and 6B, the resealable lidding film may include a peel tab (30a, 30b) that is formed from an extension of the resealable lidding film that a user may grasp to open the packaging unit. The peel tab may be placed on any side of the resealable lidding film and at any position on any side or corner of the resealable lidding film. In certain embodiments, the peel tab is at the corner of the resealable lidding film 30a, while in other embodiments, the peel tab is on the leading edge of the resealable lidding film 30b.

The resealable lidding film may be attached to a compostable container by any suitable adhesive or method including, but not limited to, a heat seal method or a compressible seal method. In some embodiments, the resealable lidding film is heat sealed to a compostable container, where the sealed portion of the lidding film has an inner seal line and an outer seal line. In certain embodiments the inner seal line and an outer seal line are positioned on a surface or lip of the compostable container that surrounds or forms the opening.

According to the embodiments described herein, the resealable lidding film may include two or more layers of film material. Suitable base materials for each layer of film include, but are not limited to, polyester, polyethylene (PE), polyethylene terephthalate (PET), amorphous polyethylene terephthalate (APET), and other polyalkenes; poly-propylene (PP) and other polyvinyls; polyvinyl chloride and other polystyrenes; silicone rubber and other polysiloxanes; natural rubber and other polydiens. polyactic acid (PLA) film, cellulose, or any other suitable polymer. The film layers may be extruded from a single polymer and/or blends of various polymers where each polymer performs a specific function, such as contributing permeability, strength, transparency, sealability, or machineability, to meet specific product requirements. In some embodiments, the base material is the same for each layer of film, while in other embodiments, one or more layers of film is of a different base material than the other layer(s). In other embodiments, the base material is different for each layer of film.

Traditional polyester lidding film that is normally used with plastic containers is not always ideal for use as a resealable lidding film with certain compostable materials like fiber-based materials. Thus, in certain embodiments, at least the first (or bottom) layer of film that directly attaches to the container is designed to create a stronger bond to compostable materials than standard film base materials. In such embodiments the base material of the film is coated with a material that improves the seal between the compostable material and the film. In some embodiments, the base material of the first (or bottom) layer of film is coated with ethyl vinyl acetate to form an ethylene vinyl acetate (EVA) coated film. The EVA coating may be delivered by solvent dispersion, or alternatively, by a laminated extrusion coating of EVA, or of EVA and polyethylene (or any other suitable polymer). In other embodiments, each layer of film is an EVA coated film. In the embodiments using EVA coated film, the packaging unit may include a coated or uncoated compostable container. In one embodiment, the packaging unit includes a resealable lidding film produced from EVA coated film that is heat sealed to a coated compostable container (e.g., fiber-based container). In another embodiment, the packaging unit includes a resealable lidding film produced from EVA coated film that is heat sealed to a coated fiber-based container. Any commercially available EVA-coated film may be used in accordance with the embodiments described herein (e.g., Terphane SEALPHANE 10.64T or 10.64HT; Dupont EVA coated films), but the EVA-coated film can be produced from a base film material coated with a modified EVA in a solvent dispersion.

The resealable lidding film also includes at least one adhesive layer between the layers of film materials. In some embodiments, the resealable lidding film includes one adhesive layer between two film layers. In other embodiments, the resealable lidding film includes two adhesive layers between three film layers. In some embodiments, the one or more adhesive layer(s) is be a pressure sensitive adhesive. Suitable pressure sensitive adhesives that may be used in accordance with the embodiments described herein may include, but are not limited to PSAs may include various hydrophilic, super-hydrophilic and/or other similarly affinity based substances, such as acrylic polymers in water, or various hydrophobic, super-hydrophobic, anhydrous substances and/or other similarly affinity based substances, such as acrylic polymers in a petroleum based solution or solvents; Styrene-block copolymers (SBC) (e.g., polystyrene-polyisoprene-polystyrene (SIS) and polystyrene-polybutadiene-polystyrene (SBS), polystyrene/ethylene-propylene/styrene (SEPS) and polystyrene/ethylene-butylene/styrene (SEBS)) or blends of one or more of SBCs. Various acrylic polymers (e.g., Acrylic acid, Acrylic acid, 2 ethylhexyl ester, Acrylic acid, 2-hydroxypropyl ester, Acetic acid, vinyl ester, Methacrylic acid, methyl ester or 2-Methyl-4-isothiazolin-3-one), rubber, synthetic thermoplastic elastomer, silicone-based adhesives or any other materials as may be contemplated by those skilled in the art. In certain embodiments, the PSA may also include one or more additional components including, but not limited to, tackifiers, antioxidants (e.g., 2,6-Di-tert.-butyl-p-cresol and the like), oils, plasticizers, surfactants and/or various other additives. Pressure sensitive adhesive layers according to some embodiments utilize a wet or fluid adhesive that remains “open” in that it does not cure dry but remains “tacky” to the touch. In some embodiments, adhesive layer is water-based, and in certain aspects, the water-based adhesive layer is modified to be moisture resistant and to resist or prevent whitening of the adhesive.

Two-layer resealable lidding films. In some embodiments, a resealable lidding film includes two layers of film material. A two layer resealable lidding film has a first layer with a bottom surface capable of being attached to a compostable container and a top surface that is attached to a second layer via a pressure sensitive adhesive layer. An example of a two layer resealable lidding film is discussed in Example 1 below. A release coating is applied to at least a portion of the top surface of the first layer of the two layer resealable lidding film. In addition, the first layer of the two layer resealable lidding film has one or more score lines which allow for the separation of the two film layers and consequently, the opening of the container. The release coating and the score lines are discussed in detail below. The second layer of the two layer resealable lidding film lacks score lines.

Three-layer resealable lidding films. In certain embodiments, a resealable lidding film includes three layers of film material. A three layer resealable lidding film has a first layer with a bottom surface capable of being attached to a compostable container and a top surface that is attached to a second layer via a first adhesive layer. The three layer resealable lidding film also has a third surface with a bottom surface that is attached to the second layer via a second adhesive layer.

In some embodiments the first adhesive layer is a pressure sensitive adhesive layer, the second adhesive layer is a permanent adhesive, and a release coating is applied to at least a portion of the top surface of the first layer of the three layer resealable lidding film. In such embodiments, the first layer of the three layer resealable lidding film has one or more score lines which allow for the separation of the first film layer from the second and third film layer and consequently, the opening of the container. The second and third layers of this three layer resealable lidding film lacks score lines. An example of a three layer resealable lidding film according to this embodiment is discussed in Example 2 below. The release coating and the score lines are discussed in detail below.

In other embodiments the first adhesive layer is a permanent adhesive layer, the second adhesive layer is a pressure sensitive adhesive layer, and a release coating is applied to at least a portion of the top surface of the second layer of the three layer resealable lidding film. In such embodiments, the first and second layers of the three layer resealable lidding film have one or more score lines which allow for the separation of the first and second layers from the third film layer and consequently, the opening of the container. The third layer of this three layer resealable lidding film lacks score lines. The release coating and the score lines are discussed in detail below.

Release Coating. According to the embodiments described herein, the first or second layer of film may include a release feature, or a “release coating” that is applied to at least a portion of the top surface of the first or second layer. In certain embodiments, the release coating is a dispersion of polyamide resin applied in a predetermined amount as indicated as a percentage coating.

In certain embodiments, the release coating is part of an adhesive dampening feature that is formed by the interface between a pressure sensitive adhesive layer and the release coating that is applied to at least a portion of the top surface of the first or second layer. In some embodiments, the release coating is applied as a flood treatment to the entire top surface of the first or second layer, while in other embodiments, the release coating is applied as a spot treatment to a portion of the top surface of the first or second layer. In particular, the spot treatment is applied to a corner or edge (e.g., lead edge) of the top surface of the first or second layer that corresponds to the peel tab location according to some embodiments. In another embodiment, the release coating is applied as a flood treatment to the entire top surface of the first or second layer and also as a spot treatment to produce a heavier layer of the same release coating at the corner or edge (e.g., lead edge) of the top surface of the first or second layer that corresponds to the peel tab location.

This release coating is advantageous in packaging units that include compostable (e.g., fiber-based) containers because it allows the film layer to require less peel force than conventional resealable film. This is important because seal strength on film to fiber is far less than regular PET lidding film to PET or other plastic trays. Resealable film requires a certain amount of adhesion strength to the trays, and the strength needs to be greater than the peel force required to separate the two or three layers of film. Thus, the release coating makes it easier to open the resealable lidding film of the packaging unit. To open the resealable lidding film, the first and second layers are separated by peeling back an outer portion of the lidding film as discussed further in the examples below.

The release coating may be applied in differing amounts to affect the seal strength of the reseal portion (i.e., flange) depending on the application. The ease of opening the resealable lidding film (i.e., the ease of release) is also be adjusted by applying different amounts of the release coating. In one embodiment, the ease of release/strength of the seal can be adjusted by applying a predetermined amount of release coating to the opening tab area. The coating is a dispersion of polyamide resin. The coating may be applied at a 100% coating to maximize the ease of release (and minimize the strength of the seal). As the percentage coating goes down, the ease or release is also reduced, and the strength of the seal is increased. In certain embodiments, the percent release coating applied is 100%, 90%, 80%, 70%, 60%, 50%, 40%, 30%, 20%, 10%, 5%, about 95% to about 100%, about 90% to about 95%, about 85% to about 90%, about 80% to about 85%, about 75% to about 80%, about 70% to about 75%, about 65% to about 70%, about 60% to about 65%, about 55% to about 60%, about 50% to about 55%, about 45% to about 50%, about 40% to about 45%, about 35% to about 40%, about 30% to about 35%, about 25% to about 30%, about 20% to about 25%, about 15% to about 20%, about 10% to about 15%, about 5% to about 10%, or less than 5%. The release coating is applied to the first or second layer using either flexo or gravure anilox rolls (or cylinders). In certain embodiments, the coating is flooded over the entire top surface of the first or second layer of film but also includes an extra amount at the pull tab area.

When designing the packaging unit, the package needs to have a balance of holding weight during its use, including shipping of the product. The weight it can carry is a factor of the tensile direction (TD) strength. The TD strength can be increased or decreased by (i) making the flange (item 16 as disclosed in the Examples and figures) wider or narrower (respectively), (ii) by a custom manipulation of the release coating both in terms of the quantity applied (deposit) and the screen value we use for applying the coating at less than 100% if needed (a higher percentage coating corresponds to a decreased TD strength), or a combination of (i) and (ii).

Score Lines. The first and/or second layer of film also includes one or more score lines that create a frangible connection between a flange portion of the first and/or second layer that remains attached to the container and the rest of the resealable lidding film, which is peeled back upon being opened by a user, exposing (i) the top surface and release coating of first second layer and (ii) the bottom surface of the second or third layer and adhesive layer. During resealing, the top layer(s) (i.e., second and/or third layers) is then realigned to overlay the flange portion.

In some embodiments, the first and/or second layer includes an inner score line and an outer score line, creating an inner frangible connection and an outer frangible connection when in a closed configuration. The scoring can be done with either a laser or a metal rotary or flatbed die cutter. The score lines can be of any desired size or shape in conjunction with the tray size and can be modified based on customer needs for the size of opening desired. The inner score line and outer score line demarcate three sections of the first and/or second layer: the peripheral section, which is the section that lies peripherally to the outer score line; the flange section, which includes a section that attaches to the container (the attachment section) and a section that extends toward the center of the container (the overhang section); and a cover section that covers the contents of the container in the closed configuration.

Venting. According to some embodiments, the resealable lidding films described herein may include laser-perforated or micro-perforated holes of various quantity, patterns and sizes to control the atmosphere inside of the packaging unit to extend the shelf like for any product, including non-food products or fresh food products that respire at a fast or medium rate such as lettuce, leafy greens, carrots, and celery. The number and size of holes differs with the produce being packaged. With new products not previously packaged, different numbers of holes are tested to see what works best for air flow, according to some embodiments. In addition, food science calculations may be used to determine the optimal oxygen transmission rate (OTR) of the package. A pattern of perforated or micro-perforated holes may be generated or designed based on the OTR calculation. Micro-perforated packaging materials that are designed to modify or control the flow of oxygen and carbon dioxide into and out of a fresh produce container, and OTR calculations for use in designing perforated or micro-perforated packaging materials based on those calculations can be found, for example, in U.S. Pat. No. 10,589,917 and 7,083,837, both of which are incorporated by reference in their entirety as if fully set forth herein.

In some embodiments, the size of the holes is between about 50 microns to 90 microns. There are a number of benefits that are derived from having a hole size of 50 to 90 microns. These are smaller holes and there are more of them to provide the same air flow. The higher quantity of holes reduces the impact if one or more holes is blocked due to food product being in the way of a hole, or, if a tray or other item is placed on top of the package during shipping or storage. The smaller holes more effectively block external contaminants and foreign particles from entering packaging. There tends to be less adhesive flow into the center of hole, which avoids hole blockage by adhesive.

Methods of Manufacture. A method of manufacturing a resealable lidding film like those described according to the embodiments is provided herein. According to some embodiments, the manufacturing method includes a first step of coating a first (or bottom) layer of film with a release coating using a first cylinder (e.g., gravure or anilox roll) as discussed above. The manufacturing method may also include a second step of applying a pressure sensitive adhesive to the top surface of the first layer using a second cylinder (e.g., gravure cylinder) according to some embodiments. The manufacturing method may also include a third step of drying the pressure sensitive adhesive by passing the first layer by a series of dryers according to certain embodiments, rendering the adhesive “tacky” but not completely dry. The manufacturing method may also include a fourth step of feeding the first layer through a feed roller, and a fifth step of adhering the first layer to a second film layer by passing the first layer and second layer through nip rollers that press and secure the top layer and first film layer together by virtue of the pressure sensitive adhesive according to certain embodiments. The manufacturing method may also include a sixth step of scoring the first layer by passing the film through a die cutter or laser cutter and a seventh step of perforating the first and second layers using a laser according to certain embodiments. The manufacturing method may include a step of winding the film formed by the steps discussed above onto a spool in preparation for the second process of being heat sealed onto a compostable container in a conventional manner.

In another embodiment, a method of manufacturing resealable lidding film for use in heat sealable tray sealing machines is provided. Such methods may include a step of laminating a polymeric first film layer, a pressure sensitive adhesive layer and a polymeric top layer to form a resealable lidding film having a peripheral edge; perforating the multi-layer film; leaving the second film layer without scoring; and scoring the first film layer to create an inner frangible connection and an outer frangible connection, the inner frangible connection and the outer frangible connection being spaced inwardly from a peripheral edge of the first film layer; such that the second film layer and the first film layer remain adhered along the peripheral edge and in a central portion of the multi-layer film when pressure Is applied to the peripheral edge of the multi-layer film to break the outer frangible connection and the inner frangible connection causing the second film layer to separate from the first film layer while leaving a portion of the first film layer between the inner frangible connection and the outer frangible connection as a resealing flange. The method may also include at least one supplemental layer that is adhered by adhesive to another side of the second film layer, opposed to the first film layer.

In another embodiment, a method of manufacturing a resealable vented multilayer film for use in heat sealable tray sealing machines. The method involves a first step of laminating a polymeric first film layer, a pressure sensitive adhesive layer and a polymeric second film layer to form a multi-layer film having a peripheral edge. The method involves a second step of perforating the multi-layer film. The method involves a third step of scoring the first film layer to create a frangible connection. The frangible connection is spaced inwardly from a peripheral edge of the first film layer. The second film layer and the first film layer remain adhered in a central portion of the multi-layer film, while the second film layer separates from the first film layer along the peripheral edge leaving a portion of the first film layer as a resealing flange defined by the positioning of the frangible connection. According to another aspect there is provided a resealable vented multilayer film, which consists of a perforated multi-layer firm comprising a polymeric first film layer laminated by a pressure sensitive adhesive layer to a polymeric second film layer. The multi-layer film has a peripheral edge. The first film layer is scored to create a frangible connection. The frangible connection is spaced inwardly from a peripheral edge of the multi-layer film so that a portion of the first film layer provides a resealing flange.

The following examples are intended to illustrate various embodiments of the invention. As such, the specific embodiments discussed are not to be construed as limitations on the scope of the invention. It will be apparent to one skilled in the art that various equivalents, changes, and modifications may be made without departing from the scope of invention, and it is understood that such equivalent embodiments are to be included herein. Further, all references cited in the disclosure are hereby incorporated by reference in their entirety, as if fully set forth herein.

### EXAMPLES

### Example 1: Two-Layer Resealable Lidding Film

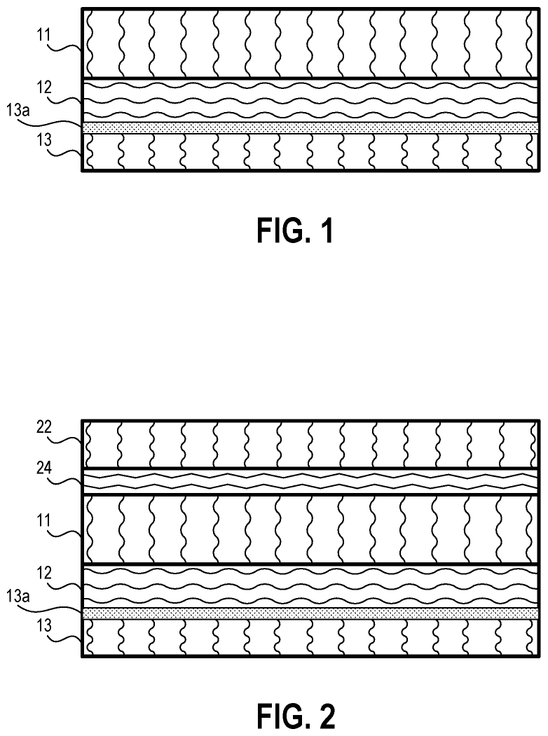

As shown in FIGS. 1, 3, and 5, the resealable lidding film 10 includes two layers of film material: a first (or bottom) layer 13 and a second (or top) layer 11. The first layer 13 includes a release coating 13a applied to its top surface. The resealable lidding film 10 also includes an adhesive layer 12 that joins together first layer 13 with second layer 11.

As shown in FIG. 5, the first layer 13 of the resealable lidding film includes an inner score line 18a and an outer score line 18b, creating an inner frangible connection and an outer frangible connection when in a closed configuration. The scoring 18a, 18b can be done with either a laser or a metal rotary or flatbed die cutter. The score lines can be of various size in conjunction with the tray size and can be modified based on customer needs for the size of opening desired. The lidding film 10 is heat sealed to the rigid or semi rigid tray 20. The inner score line 18a and outer score line 18b divide the first layer 13 (to include the release coating 13a) into three sections: the peripheral section 13b, which is the section that lies peripherally to the outer score line 18b; the flange section 16, which includes a section that attaches to the container 20 (the attachment section 16a) and a section that extends toward the center of the container 20 (the overhang section 16b); and a cover section 13c that covers the contents of the container 20 in the closed configuration.

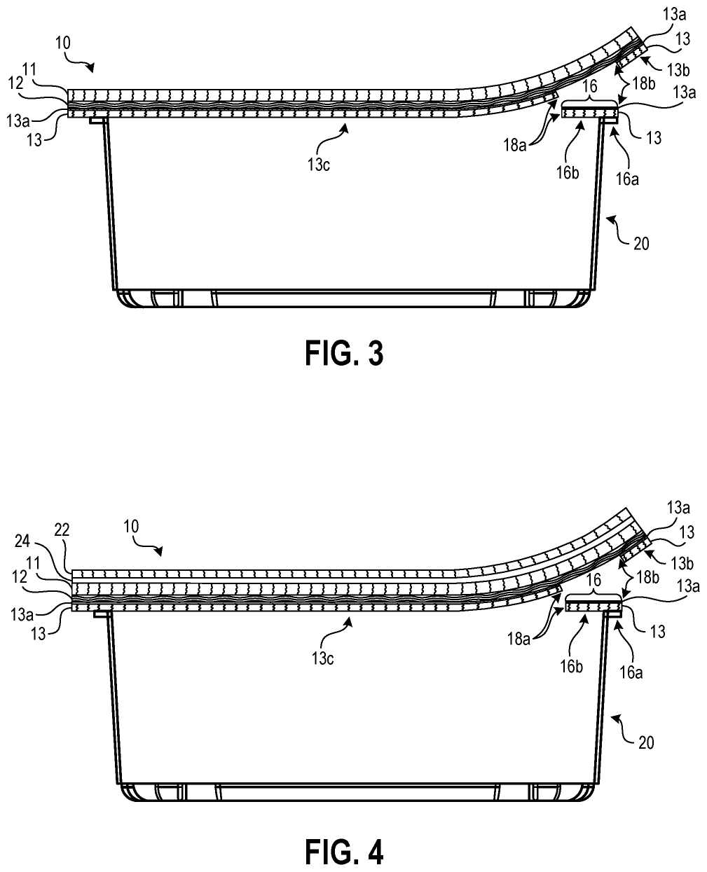

As illustrated in FIG. 3, when upward pressure is applied to the resealable lidding film at the peripheral section 13b of the first layer, the inner and outer frangible connections are broken at the inner and outer score lines 18a, 18b, respectively, causing the second layer of the film to separate from the first layer of the film, while leaving the flange portion 16 attached to the container 20 at the attachment section 16a. In this open configuration, the top surface of the flange section 16 corresponds to a resealing area, wherein the user can close or reseal the lidding film by reattaching the second layer to the first layer by virtue of the tacky nature of the adhesive layer 12 exposed on the second layer. The flange section 16 can be of various widths and is necessary to ensure the support of weight when the product is shipped and adjusted to meet access requirements of the client.

### Example 2: Three-Layer Resealable Lidding Film

As shown in FIGS. 2, 4, and 5, the resealable lidding film 10 includes three layers of film material: a first (or bottom) layer 13, a second layer 11, and a third layer 22. In certain embodiments, the third layer is a printed layer. The first layer 13 includes a release coating 13a applied to its top surface. The resealable lidding film 10 also includes a first adhesive layer 12 that joins together first layer 13 with second layer 11 and a second adhesive layer 24 that joins together the second layer 11 with the third layer 22.

As shown in FIG. 5, the first layer 13 of the resealable lidding film includes an inner score line 18a and an outer score line 18b, creating an inner frangible connection and an outer frangible connection when in a closed configuration. The scoring 18a, 18b can be done with either a laser or a metal rotary or flatbed die cutter. The score lines can be of various size in conjunction with the tray size and can be modified based on customer needs for the size of opening desired. The lidding film 10 is heat sealed to the rigid or semi rigid tray 20. The inner score line 18a and outer score line 18b divide the first layer 13 (to include the release coating 13a) into three sections: the peripheral section 13b, which is the section that lies peripherally to the outer score line 18b; the flange section 16, which includes a section that attaches to the container 20 (the attachment section 16a) and a section that extends toward the center of the container 20 (the overhang section 16b); and a cover section 13c that covers the contents of the container 20 in the closed configuration.

As illustrated in FIG. 4, when upward pressure is applied to the resealable lidding film at the peripheral section 13b of the first layer, the inner and outer frangible connections are broken at the inner and outer score lines 18a, 18b, respectively, causing the second layer of the film to separate from the first layer of the film, while leaving the flange portion 16 attached to the container 20 at the attachment section 16a. The third layer 22 is not intended to separate from the other layers and therefore remains attached to the second layer 11, and the second adhesive layer 24 used is not pressure-sensitive. In this open configuration, the top surface of the flange section 16 corresponds to a resealing area, wherein the user can close or reseal the lidding film by reattaching the second layer to the first layer by virtue of the tacky nature of the adhesive layer 12 exposed on the second layer. The flange section 16 can be of various widths and is necessary to ensure the support of weight when the product is shipped and adjusted to meet access requirements of the client.

### Example 4: Resealable Lidding Film with Scoring Detail, Corner Peel Tab, and Release Coating

FIG. 6A shows a resealable lidding film 10 in accordance with the embodiments described above in Examples 1 and 2. The resealable lidding film shown in FIG. 6A includes an inner score line 18a similar to that shown in FIG. 5 and an outer score line 18b that is located at the peel tab 30a, corresponding to a corner of the resealable lidding film 10. The release coating 13a is applied to the first layer 13 as a spot treatment at the corner corresponding to the peel tab 30a to facilitate the separation of the first layer from the second (and optionally the third) layer(s). FIG. 6A also shows optional laser perforations or micro-perforations 14.

The inner and outer score lines 18a, 18b create an inner frangible connection and an outer frangible connection when in a closed configuration. The scoring 18a, 18b can be done with either a laser or a metal rotary or flatbed die cutter. The score lines can be of various sizes and locations in conjunction with the tray size and location of the peel tab and can be modified based on customer needs for the size of opening desired. The lidding film 10 is heat sealed to a rigid or semi rigid tray 20. The inner score line 18a and outer score line 18b divide the first layer 13 (to include the release coating 13a) into three sections: the peripheral section 13b, which is the section that lies peripherally to the outer score line 18b; the flange section 16, which includes a section that attaches to the container 20 (the attachment section 16a) and a section that extends toward the center of the container 20 (the overhang section 16b); and a cover section 13c that covers the contents of the container 20 in the closed configuration.

### Example 5: Resealable Lidding Film with Scoring Detail, Leading Edge Peel Tab

FIG. 6B shows a resealable lidding film 10 in accordance with the embodiments described above in Examples 1 and 2. The resealable lidding film shown in FIG. 6B includes an inner score line 18a similar to that shown in FIG. 5 and an outer score line 18b that is located at the peel tab 30b, corresponding to the leading edge of the resealable lidding film 10.

The inner and outer score lines 18a, 18b create an inner frangible connection and an outer frangible connection when in a closed configuration. The scoring 18a, 18b can be done with either a laser or a metal rotary or flatbed die cutter. The score lines can be of various sizes and locations in conjunction with the tray size and location of the peel tab, and can be modified based on customer needs for the size of opening desired. The lidding film 10 is heat sealed to a rigid or semi rigid tray 20. The inner score line 18a and outer score line 18b divide the first layer 13 (to include the release coating 13a) into three sections: the peripheral section 13b, which is the section that lies peripherally to the outer score line 18b; the flange section 16, which includes a section that attaches to the container 20 (the attachment section 16a) and a section that extends toward the center of the container 20 (the overhang section 16b); and a cover section 13c that covers the contents of the container 20 in the closed configuration.

### Example 6: Method of Manufacture

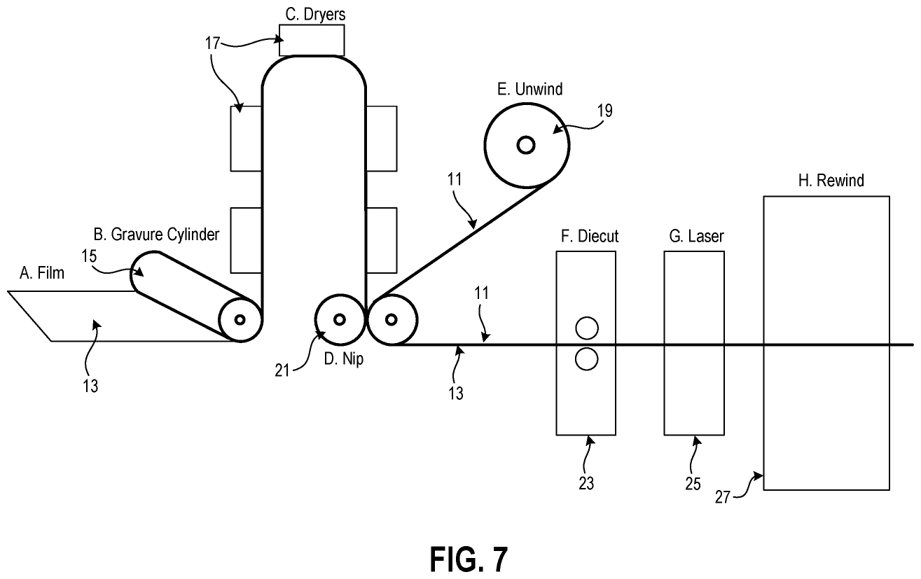

Referring to FIG. 7, there is illustrated first film layer 13 being pulled past a cylinder 15 which applies pressure sensitive adhesive 12. The first film layer 13 is then passed by a series of dryers 17. As described above, pressure sensitive adhesive layer 12 does not cure dry, but remains “tacky” to the touch. This enables the top layer 11 to be resealed to the remaining edge flange of bottom layer 13. A second film layer 11 is then fed from feed roller 19 and top layer 11 is adhered to the first film layer 13 by passing through nip rollers 21, which press the second film layer 11 and the first film layer 13 together. As second film layer 11 and first film layer 13 exit nip rollers 21, they are secured together by an adhesive layer (e.g., a pressure sensitive adhesive) 12. First film layer 13 is then scored by passing through die cutter 23. Both second film layer 11 and first film layer 13 are then perforated by a laser 25. The film formed, which includes the second film layer 11, adhesive layer 12 and first film layer 13 is then wound onto a spool (shown as block 27) in preparation for the process of being heat sealed onto a compostable container in a conventional manner. Not shown is a step of coating the first layer of film with a release coating using a gravure or anilox roll prior to pulling the first film layer past the cylinder 15.

### Example 5: Filmic Pressure Sensitive Label Applied to Sealant Layer

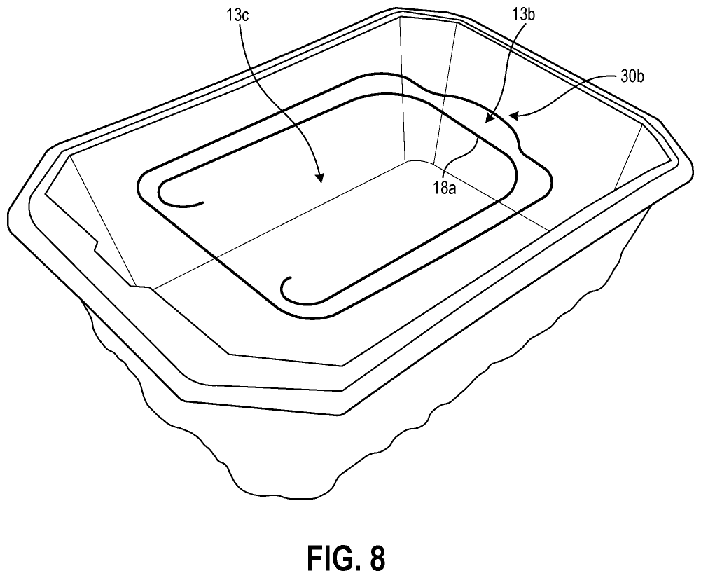

FIG. 8 shows another embodiment in accordance with the lidding films described herein, and item numbers represent the same feature across all figures unless otherwise indicated. In this embodiment a filmic pressure sensitive label is applied to the top of the sealant layer and is undercut to allow for opening to the package as shown in FIG. 8. The pressure sensitive label shown in FIG. 8 includes features similar to those shown in FIG. 6B, including an inner score line 18a and an outer score line (line distal to 18a) that is located near the peel tab 30b, corresponding to the leading edge of the label.

The inner and outer score lines create an inner frangible connection and an outer frangible connection when in a closed configuration. The scoring can be done with either a laser or a metal rotary or flatbed die cutter. The score lines can be of various sizes and locations in conjunction with the tray size and location of the peel tab and can be modified based on customer needs for the size of opening desired. The lidding is heat sealed to a rigid or semi rigid tray. The inner score line and outer score line divide the first layer (to include the release coating) into different sections including a peripheral section 13b, which is the section that lies peripherally to the outer score line and a cover section 13c that covers the contents of the container in the closed configuration.

I/We claim:

1. A resealable lidding film comprising:
a first layer capable of being attached to a compostable container comprising:
a top surface;
a bottom surface;
a release coating applied to at least a portion of the top surface of the first layer; and
one or more score lines;
a second layer lacking score lines; and
an adhesive layer between the release coating of the first layer and the second layer.

2. The resealable lidding film of claim 1, further comprising a third layer and a permanent adhesive layer between the second and third layer.

3. A resealable lidding film comprising:
a first layer capable of being attached to a compostable container;
a second layer having a release coating applied to at least a portion of a top surface of the second layer; and
one or more score lines through the first and second layers;
a third layer lacking score lines;
a permanent adhesive layer between the first and second layers; and
a pressure sensitive adhesive layer between the second and third layers.

4. A packaging unit comprising:
a compostable container having an opening and a receptable for holding goods; and
a resealable lidding film of claim 1.

5. The packaging unit or resealable lidding film of claim 1, wherein the compostable container is fiber-based.

6. The packaging unit or resealable lidding film of claim 1, wherein the release coating is applied to the first layer in a flood treatment.

7. The packaging unit or resealable lidding film of claim 1, wherein the release coating is applied as a spot treatment at or near a peel tab.

8. The packaging unit or resealable lidding film of claim 1, wherein the release coating causes a reduction in peel force between the adhesive layer and the first layer.

9. The packaging unit or resealable lidding film of claim 1, wherein the first layer is an EVA coated film.

10. The packaging unit or resealable lidding film of claim 1, wherein the adhesion strength of the attachment between the first bottom surface to the fiber container is greater than the peel force needed to separate the adhesive layer and the first/bottom layer.

11. The packaging unit or resealable lidding film of claim 1, wherein the first layer comprises an inner score line and an outer score line.

12. The packaging unit or resealable lidding film of claim 11, wherein the first layer comprises a peripheral section, a flange section between the inner and outer score lines, and a cover section.
